(19) United States
(12) Patent Application Publication
(10) Pub. No.: US 2026/0300092 A1
(43) Pub. Date: Oct. 1, 2026

(54) DYNAMIC DECODING METHOD, MEMORY STORAGE DEVICE, AND MEMORY CONTROL CIRCUIT UNIT

(71) Applicant: PHISON ELECTRONICS CORP., Miaoli (TW)

(72) Inventors: Yu-Hsiang Lin, Yunlin County (TW); Bo Lun Huang, Tainan City (TW)

(73) Assignee: PHISON ELECTRONICS CORP., Miaoli (TW)

(21) Appl. No.: 19/182,666

(22) Filed: Apr. 18, 2025

(30) Foreign Application Priority Data
Mar. 31, 2025 (TW) 114112337

(51) Int. Cl. G06F 11/10

(52) U.S. Cl. CPC G06F 11/106; G06F 11/1016; G06F 11/1068

(57) ABSTRACT

A dynamic decoding method, a memory storage device, and a memory control circuit unit are provided. The dynamic decoding method includes: reading a first codeword from a physical unit of a non-volatile memory module, and the first codeword includes at least two groups; executing a decoding operation according to a first group of the first codeword; checking whether syndrome data of the first codeword is equal to zero in the decoding operation; and outputting the first codeword in response to the syndrome data being equal to zero.

### CROSS-REFERENCE TO RELATED APPLICATION

This application claims the priority benefit of Taiwan application serial no. 114112337, filed on Mar. 31, 2025. The entirety of the above-mentioned patent application is hereby incorporated by reference herein and made a part of this specification.

### BACKGROUND

### Technical Field

The disclosure relates to a memory management technology, and more particularly to a dynamic decoding method, a memory storage device, and a memory control circuit unit.

### Description of Related Art

Portable electronic devices such as mobile phones and notebook computers have grown rapidly in the past few years, which has led to a rapid increase in consumer demand for storage media. As the rewritable non-volatile memory module (for example, a flash memory) has characteristics such as non-volatile data, power saving, small volume, and no mechanical structure, the rewritable non-volatile memory module is very suitable for being built into various portable electronic devices exemplified above.

A decoding operation is executed on data in the rewritable non-volatile memory module according to an error correcting code when the data is read. If the data read from the rewritable non-volatile memory module has error bits, decoding time will increase. In a conventional iterative decoding operation, the error bits in the data may be successfully corrected during the decoding operation, resulting in error convergence. However, each iteration operation is executed according to a complete codeword, and unnecessary calculations may be executed on converged bits in subsequent iteration operations, thereby affecting performance.

### SUMMARY

The disclosure provides a dynamic decoding method, a memory storage device, and a memory control circuit unit, which can greatly improve decoding speed, reduce hardware cost, and maintain error correction ability.

An exemplary embodiment of the disclosure provides a dynamic decoding method for a rewritable non-volatile memory module. The dynamic decoding method includes the following steps. A first codeword is read from a physical unit of the rewritable non-volatile memory module. The first codeword includes at least two groups. A decoding operation is executed according to a first group of the first codeword. Whether syndrome data of the first codeword is equal to zero is checked in the decoding operation. The first codeword is output in response to the syndrome data being equal to zero.

In an exemplary embodiment of the disclosure, the dynamic decoding method further includes the following step. The decoding operation is executed according to the complete first codeword after completing the decoding operation executed according to the first group in response to the syndrome data being not equal to zero.

In an exemplary embodiment of the disclosure, the dynamic decoding method further includes the following steps. Whether a current iteration number of the decoding operation is less than a predetermined number is judged. The decoding operation is executed according to the first group in response to the current iteration number being less than the predetermined number.

In an exemplary embodiment of the disclosure, the dynamic decoding method further includes the following step. The decoding operation is executed according to the complete first codeword in response to the current iteration number being not less than the predetermined number.

In an exemplary embodiment of the disclosure, decoding abilities of the at least two groups are different, and the decoding ability of the first group is lower than the decoding ability of a second group of the first codeword.

In an exemplary embodiment of the disclosure, the dynamic decoding method further includes the following steps. A lookup table is established based on the at least two groups. The lookup table is queried according to a current iteration number of the decoding operation to judge whether to execute the decoding operation according to one of the at least two groups or the complete first codeword.

An exemplary embodiment of the disclosure further provides a memory storage device, which includes a connection interface unit, a rewritable non-volatile memory module, and a memory control circuit unit. The connection interface unit is coupled to a host system. The memory control circuit unit is coupled to the connection interface unit and the rewritable non-volatile memory module. The memory control circuit unit is configured to issue a read instruction sequence to the rewritable non-volatile memory module. The read instruction sequence is configured to instruct to read a first codeword from a physical unit of the rewritable non-volatile memory module. The first codeword includes at least two groups. The memory control circuit unit is further configured to execute a decoding operation according to a first group of the first codeword. The memory control circuit unit is further configured to check whether syndrome data of the first codeword is equal to zero in the decoding operation. The memory control circuit unit is further configured to output the first codeword in response to the syndrome data being equal to zero.

In an exemplary embodiment of the disclosure, the memory control circuit unit is further configured to execute the decoding operation according to the complete first codeword after completing the decoding operation executed according to the first group in response to the syndrome data being not equal to zero.

In an exemplary embodiment of the disclosure, the memory control circuit unit is further configured to judge whether a current iteration number of the decoding operation is less than a predetermined number. The memory control circuit unit is further configured to execute the decoding operation according to the first group in response to the current iteration number being less than the predetermined number.

In an exemplary embodiment of the disclosure, the memory control circuit unit is further configured to execute the decoding operation according to the complete first codeword in response to the current iteration number being not less than the predetermined number.

In an exemplary embodiment of the disclosure, the memory control circuit unit is further configured to establish a lookup table based on the at least two groups. The memory control circuit unit is further configured to query the lookup table according to a current iteration number of the decoding operation to judge whether to execute the decoding operation according to one of the at least two groups or the complete first codeword.

An exemplary embodiment of the disclosure further provides a memory control circuit unit, which is disposed in a memory storage device. The memory control circuit unit includes a host interface, a memory interface, and a memory management circuit. The host interface is coupled to a connection interface unit. The memory interface is coupled to a rewritable non-volatile memory module. The memory management circuit is coupled to the host interface and the memory interface. The memory management circuit is configured to issue a read instruction sequence to the rewritable non-volatile memory module. The read instruction sequence is configured to instruct to read a first codeword from a physical unit of the rewritable non-volatile memory module. The first codeword includes at least two groups. The memory management circuit is further configured to execute a decoding operation according to a first group of the first codeword. The memory management circuit is further configured to check whether syndrome data of the first codeword is equal to zero in the decoding operation. The memory management circuit is further configured to output the first codeword in response to the syndrome data being equal to zero.

In an exemplary embodiment of the disclosure, the memory management circuit is further configured to execute the decoding operation according to the complete first codeword after completing the decoding operation executed according to the first group in response to the syndrome data being not equal to zero.

In an exemplary embodiment of the disclosure, the memory management circuit is further configured to judge whether a current iteration number of the decoding operation is less than a predetermined number. The memory management circuit is further configured to execute the decoding operation according to the first group in response to the current iteration number being less than the predetermined number.

In an exemplary embodiment of the disclosure, the memory management circuit is further configured to execute the decoding operation according to the complete first codeword in response to the current iteration number being not less than the predetermined number.

In an exemplary embodiment of the disclosure, the memory management circuit is further configured to establish a lookup table based on the at least two groups. The memory management circuit is further configured to query the lookup table according to a current iteration number of the decoding operation to judge whether to execute the decoding operation according to one of the at least two groups or the complete first codeword.

Based on the above, in the dynamic decoding method, the memory storage device, and the memory control circuit unit of the disclosure, in response to the current iteration number being less than the predetermined number, the decoding operation may be executed only on the first group with low decoding ability in the codeword, and in response to the current iteration number being not less than the predetermined number, the decoding operation may be executed on the complete codeword, which may prevent executing unnecessary calculations on converged bits, thereby improving the decoding speed while maintaining the error correction ability.

### BRIEF DESCRIPTION OF THE DRAWINGS

FIG. 1 is a schematic diagram of a host system, a memory storage device, and an input/output (I/O) device according to an exemplary embodiment of the disclosure.

FIG. 2 is a schematic diagram of a host system, a memory storage device, and an I/O device according to an exemplary embodiment of the disclosure.

FIG. 3 is a schematic diagram of a host system and a memory storage device according to an exemplary embodiment of the disclosure.

FIG. 4 is a schematic diagram of a memory storage device according to an exemplary embodiment of the disclosure.

FIG. 5 is a schematic diagram of a memory control circuit unit according to an exemplary embodiment of the disclosure.

FIG. 6 is a schematic diagram of managing a rewritable non-volatile memory module according to an exemplary embodiment of the disclosure.

FIG. 7 is a schematic diagram of a codeword according to an exemplary embodiment of the disclosure.

FIG. 8 is a flowchart of a dynamic decoding method according to an exemplary embodiment of the disclosure.

FIG. 9 is a schematic diagram of a lookup table according to an exemplary embodiment of the disclosure.

FIG. 10 is a flowchart of a dynamic decoding method according to an exemplary embodiment of the disclosure.

### DESCRIPTION OF THE EMBODIMENTS

Generally speaking, a memory storage device (also referred to as a memory storage system) includes a rewritable non-volatile memory module and a controller (also referred to as a control circuit). The memory storage device may be used together with a host system, so that the host system may write data to the memory storage device or read data from the memory storage device.

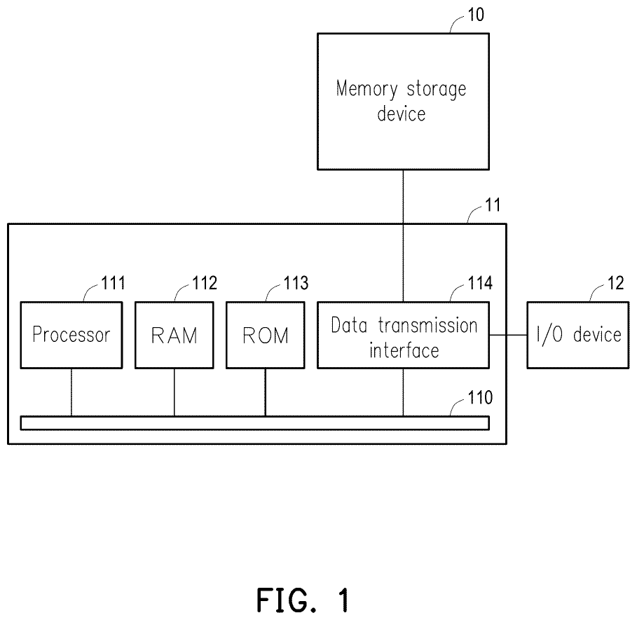

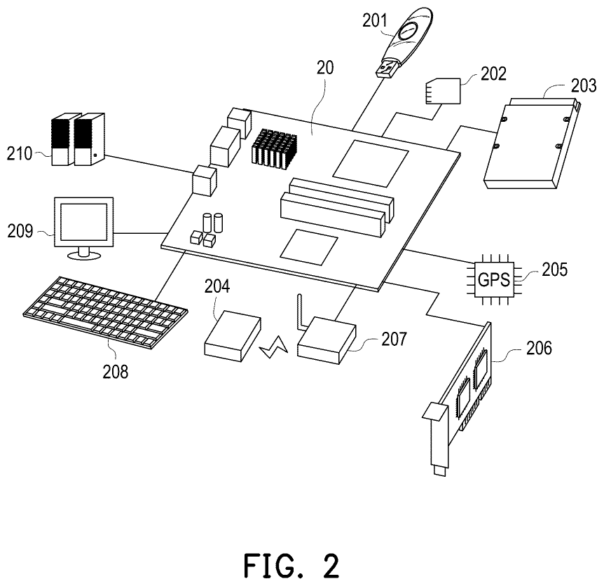

FIG. 1 is a schematic diagram of a host system, a memory storage device, and an input/output (I/O) device according to an exemplary embodiment of the disclosure. FIG. 2 is a schematic diagram of a host system, a memory storage device, and an I/O device according to an exemplary embodiment of the disclosure.

Please refer to FIG. 1 and FIG. 2. A host system 11 may include a processor 111, a random access memory (RAM) 112, a read only memory (ROM) 113, and a data transmission interface 114. The processor 111, the random access memory 112, the read only memory 113, and the data transmission interface 114 may be coupled to a system bus 110.

In an exemplary embodiment, the host system 11 may be coupled to a memory storage device 10 through the data transmission interface 114. For example, the host system 11 may store data in the memory storage device 10 or read data from the memory storage device 10 via the data transmission interface 114. In addition, the host system 11 may be coupled to the I/O device 12 through the system bus 110. For example, the host system 11 may send an output signal to the I/O device 12 or receive an input signal from the I/O device 12 via the system bus 110.

In an exemplary embodiment, the processor 111, the random access memory 112, the read only memory 113, and the data transmission interface 114 may be disposed on a motherboard 20 of the host system 11. The number of the data transmission interface 114 may be one or more. Through the data transmission interface 114, the motherboard 20 may be coupled to the memory storage device 10 via a wired or wireless manner.

In an exemplary embodiment, the memory storage device 10 may be, for example, a flash drive 201, a memory card 202, a solid state drive (SSD) 203, or a wireless memory storage device 204. The wireless memory storage device 204 may be, for example, a near field communication (NFC) memory storage device, a WiFi memory storage device, a Bluetooth memory storage device, a Bluetooth low energy memory storage device (for example, iBeacon), or other memory storage devices based on various wireless communication technologies. In addition, the motherboard 20 may also be coupled to various I/O devices such as a global positioning system (GPS) module 205, a network interface card 206, a wireless transmission device 207, a keyboard 208, a screen 209, and a speaker 210 through the system bus 110. For example, in an exemplary embodiment, the motherboard 20 may access the wireless memory storage device 204 through the wireless transmission device 207.

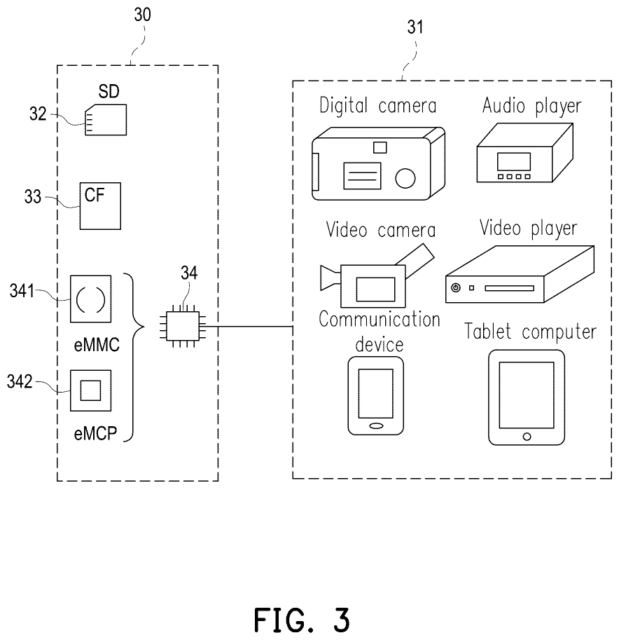

In an exemplary embodiment, the host system 11 is a computer system. In an exemplary embodiment, the host system 11 may be any system that may substantially cooperate with a memory storage device to store data. In an exemplary embodiment, the memory storage device 10 and the host system 11 may respectively include a memory storage device 30 and a host system 31 of FIG. 3.

FIG. 3 is a schematic diagram of a host system and a memory storage device according to an exemplary embodiment of the disclosure. Please refer to FIG. 3. The memory storage device 30 may be used in conjunction with the host system 31 to store data. For example, the host system 31 may be a system such as a digital camera, a video camera, a communication device, an audio player, a video player, and a tablet computer. For example, the memory storage device 30 may be various non-volatile memory storage devices, such as a secure digital (SD) card 32, a compact flash (CF) card 33, and an embedded storage device 34, used by the host system 31. The embedded storage device 34 includes various embedded storage devices, such as an embedded multi media card (eMMC) 341 and/or an embedded multi chip package (eMCP) storage device 342, in which a memory module is directly coupled to a substrate of a host system.

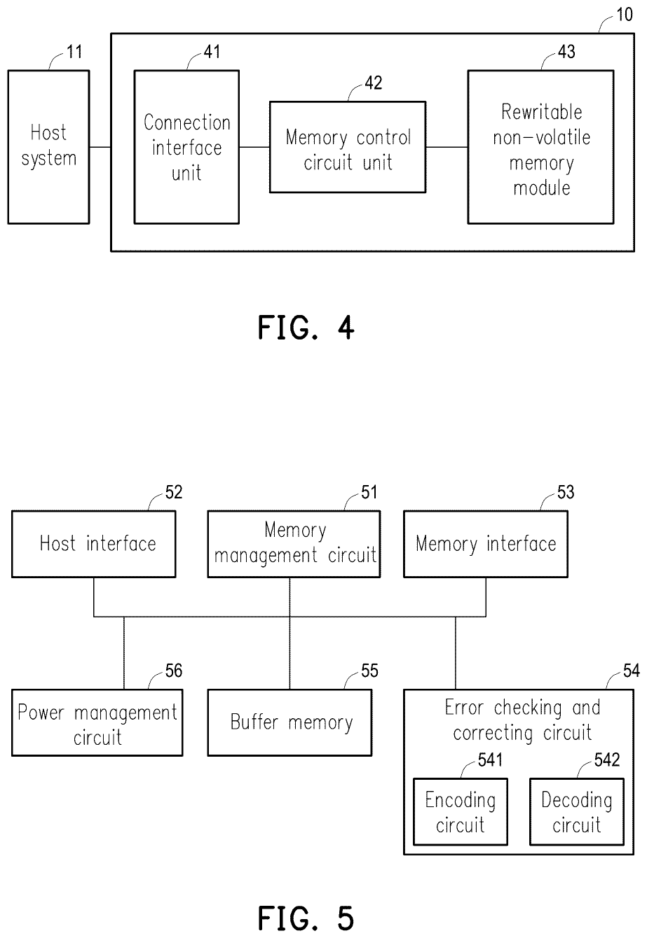

FIG. 4 is a schematic diagram of a memory storage device according to an exemplary embodiment of the disclosure. Please refer to FIG. 4. The memory storage device 10 includes a connection interface unit 41, a memory control circuit unit 42, and a rewritable non-volatile memory module 43.

The connection interface unit 41 is configured to couple to the host system 11. The memory storage device 10 may communicate with the host system 11 via the connection interface unit 41. In an exemplary embodiment, the connection interface unit 41 is compatible with the peripheral component interconnect (PCI) express standard. In an exemplary embodiment, the connection interface unit 41 may also conform to the serial advanced technology attachment (SATA) standard, the parallel advanced technology attachment (PATA) standard, the Institute of Electrical and Electronic Engineers (IEEE) 1394 standard, the universal serial bus (USB) standard, the SD interface standard, the ultra high speed-I (UHS-I) interface standard, the ultra high speed-II (UHS-II) interface standard, the memory stick (MS) interface standard, the MCP interface standard, the MMC interface standard, the eMMC interface standard, the universal flash storage (UFS) interface standard, the eMCP interface standard, the CF interface standard, the integrated device electronics (IDE) standard, or other suitable standards. The connection interface unit 41 and the memory control circuit unit 42 may be packaged in one chip or the connection interface unit 41 may be arranged outside a chip including the memory control circuit unit 42.

The memory control circuit unit 42 is coupled to the connection interface unit 41 and the rewritable non-volatile memory module 43. The memory control circuit unit 42 is configured to execute multiple logic gates or control commands implemented in the form of hardware or the form of firmware and perform operations such as data writing, reading, and erasing in the rewritable non-volatile memory module 43 according to a command of the host system 11.

The rewritable non-volatile memory module 43 is configured to store data written by the host system 11. The rewritable non-volatile memory module 43 may include a single level cell (SLC) NAND flash memory module (that is, a flash memory module that may store 1 bit in a memory cell), a multi level cell (MLC) NAND flash memory module (that is, a flash memory module that may store 2 bits in a memory cell), a triple level cell (TLC) NAND flash memory module (that is, a flash memory module that may store 3 bits in a memory cell), a quad level cell (QLC) NAND flash memory module (that is, a flash memory module that may store 4 bits in a memory cell), other flash memory modules, or other memory modules with the same characteristics.

Each memory cell in the rewritable non-volatile memory module 43 stores one or more bits with changes in voltage (hereinafter also referred to as a threshold voltage). Specifically, there is a charge trapping layer between a control gate and a channel of each memory cell. Through applying a write voltage to the control gate, the number of electrons of the charge trapping layer may be changed, thereby changing the threshold voltage of the memory cell. The operation of changing the threshold voltage of the memory cell is also referred to as “writing data to the memory cell” or “programming the memory cell”. As the threshold voltage changes, each memory cell in the rewritable non-volatile memory module 43 has multiple storage statuses. It is possible to judge which storage status a memory cell belongs to through applying a read voltage, so as to obtain one or more bits stored in the memory cell.

In an exemplary embodiment, the memory cells of the rewritable non-volatile memory module 43 may constitute multiple physical programming units, and the physical programming units may constitute multiple physical erasing units. Specifically, the memory cells on the same word line may form one or more physical programming units. If one memory cell may store more than 2 bits, the physical programming units on the same word line may be at least classified into a lower physical programming unit and an upper physical programming unit. For example, a least significant bit (LSB) of a memory cell belongs to the lower physical programming unit, and a most significant bit (MSB) of a memory cell belongs to the upper physical programming unit. Generally speaking, in the MLC NAND flash memory, the write speed of the lower physical programming unit is greater than the write speed of the upper physical programming unit and/or the reliability of the lower physical programming unit is higher than the reliability of the upper physical programming unit.

In an exemplary embodiment, the physical programming unit is the smallest unit of programming. That is, the physical programming unit is the smallest unit of writing data. For example, the physical programming unit may be a physical page or a physical sector. If the physical programming unit is a physical page, the physical programming unit may include a data bit area and a redundancy bit area. The data bit area includes multiple physical sectors for storing user data, and the redundancy bit area is configured to store system data (for example, management data such as an error correcting code). In an exemplary embodiment, the data bit area includes 32 physical sectors, and the size of one physical sector is 512 bytes (B). However, in other exemplary embodiments, the data bit area may also include 8, 16, more, or less physical sectors, and the size of each physical sector may also be greater or smaller. On the other hand, the physical erasing unit is the smallest unit of erasure. That is, each physical erasing unit includes the smallest number of memory cells to be erased together. For example, the physical erasing unit is a physical block.

FIG. 5 is a schematic diagram of a memory control circuit unit according to an exemplary embodiment of the disclosure. Please refer to FIG. 5. The memory control circuit unit 42 includes a memory management circuit 51, a host interface 52, and a memory interface 53.

The memory management circuit 51 is configured to control the overall operation of the memory control circuit unit 42. Specifically, the memory management circuit 51 has multiple control commands, and when the memory storage device 10 is operating, the control commands are executed to perform operations such as data writing, reading, and erasing. The following description of the operation of the memory management circuit 51 is equivalent to the description of the operation of the memory control circuit unit 42.

In an exemplary embodiment, the control commands of the memory management circuit 51 are implemented in the form of firmware. For example, the memory management circuit 51 has a microprocessor unit (not shown) and a read only memory (not shown), and the control commands are burnt into the read only memory. When the memory storage device 10 is operating, the control commands are executed by the microprocessor unit to perform operations such as data writing, reading, and erasing.

In an exemplary embodiment, the control commands of the memory management circuit 51 may also be stored in a specific region (for example, a system area dedicated to storing system data in a memory module) of the rewritable non-volatile memory module 43 in the form of program codes. In addition, the memory management circuit 51 has a microprocessor unit (not shown), a read only memory (not shown), and a random access memory (not shown). In particular, the read only memory has a boot code, and when the memory control circuit unit 42 is enabled, the microprocessor unit first executes the boot code to load the control commands stored in the rewritable non-volatile memory module 43 into the random access memory of the memory management circuit 51. After that, the microprocessor unit runs the control commands to perform operations such as data writing, reading, and erasing.

In an exemplary embodiment, the control commands of the memory management circuit 51 may also be implemented in the form of hardware. For example, the memory management circuit 51 includes a microcontroller, a memory cell management circuit, a memory write circuit, a memory read circuit, a memory erase circuit, and a data processing circuit. The memory cell management circuit, the memory write circuit, the memory read circuit, the memory erase circuit, and the data processing circuit are coupled to the microcontroller. The memory cell management circuit is configured to manage a memory cell or a memory cell group of the rewritable non-volatile memory module 43. The memory write circuit is configured to issue a write command sequence to the rewritable non-volatile memory module 43 to write data to the rewritable non-volatile memory module 43. The memory read circuit is configured to issue a read command sequence to the rewritable non-volatile memory module 43 to read data from the rewritable non-volatile memory module 43. The memory erase circuit is configured to issue an erase command sequence to the rewritable non-volatile memory module 43 to erase data from the rewritable non-volatile memory module 43. The data processing circuit is configured to process data to be written to the rewritable non-volatile memory module 43 and data read from the rewritable non-volatile memory module 43. The write command sequence, the read command sequence, and the erase command sequence may each include one or more program codes or command codes and are configured to instruct the rewritable non-volatile memory module 43 to execute corresponding operations such as writing, reading, and erasing. In an exemplary embodiment, the memory management circuit 51 may also issue other types of command sequences to the rewritable non-volatile memory module 43 to instruct to execute corresponding operations.

The host interface 52 is coupled to the memory management circuit 51. The memory management circuit 51 may communicate with the host system 11 through the host interface 52. The host interface 52 may be configured to obtain and identify commands and data from the host system 11. For example, the commands and the data from the host system 11 may be sent to the memory management circuit 51 through the host interface 52. In addition, the memory management circuit 51 may send the data to the host system 11 through the host interface 52. In the exemplary embodiment, the host interface 52 is compatible with the PCI express standard. However, it must be understood that the disclosure is not limited thereto. The host interface 52 may also be compatible with the SATA standard, the PATA standard, the IEEE 1394 standard, the USB standard, the SD standard, the UHS-I standard, the UHS-II standard, the MS standard, the MMC standard, the eMMC standard, the UFS standard, the CF standard, the IDE standard, or other suitable data transmission standards.

The memory interface 53 is coupled to the memory management circuit 51 and is configured to access the rewritable non-volatile memory module 43. For example, the memory management circuit 51 may access the rewritable non-volatile memory module 43 through the memory interface 53. In other words, data to be written to the rewritable non-volatile memory module 43 is converted into a format acceptable by the rewritable non-volatile memory module 43 via the memory interface 53. Specifically, if the memory management circuit 51 intends to access the rewritable non-volatile memory module 43, the memory interface 53 will send the corresponding command sequence. For example, the command sequences may include the write command sequence instructing to write data, the read command sequence instructing to read data, the erase command sequence instructing to erase data, and corresponding command sequences instructing various memory operations (such as changing a read voltage level and executing a garbage collection (GC) operation). The command sequences are, for example, generated by the memory management circuit 51 and sent to the rewritable non-volatile memory module 43 through the memory interface 53. The command sequences may include one or more signals or data on a bus. The signals or the data may include command codes or program codes. For example, the read command sequence includes information such as a read recognition code and a memory address.

In an exemplary embodiment, the memory control circuit unit 42 further includes an error checking and correcting circuit 54, a buffer memory 55, and a power management circuit 56.

The error checking and correcting circuit 54 is coupled to the memory management circuit 51 and is configured to execute error checking and correcting operations to ensure correctness of data. Specifically, when the memory management circuit 51 receives a write command from the host system 11, the error checking and correcting circuit 54 generates a corresponding error correcting code (ECC) and/or error detecting code (EDC) for data corresponding to the write command, and the memory management circuit 51 writes the data corresponding to the write command and the corresponding error correcting code and/or error detecting code to the rewritable non-volatile memory module 43. Later, when the memory management circuit 51 reads the data from the rewritable non-volatile memory module 43, the error correcting code and/or the error detecting code corresponding to the data are read at the same time, and the error checking and correcting circuit 54 executes the error checking and correcting operations on the read data according to the error correcting code and/or the error detecting code.

In an exemplary embodiment, the error checking and correcting circuit 54 may support low-density parity-check (LDPC) codes. For example, the error checking and correcting circuit 54 may use the low-density parity-check codes for encoding and decoding. In an exemplary embodiment, the error checking and correcting circuit 54 may also adopt other types of encoding/decoding algorithms, such as Bose-Chaudhuri-Hocquenghem (BCH) or Reed-Solomon (RS) codes, which is not limited by the disclosure.

The buffer memory 55 is coupled to the memory management circuit 51 and is configured to temporarily store data. The power management circuit 56 is coupled to the memory management circuit 51 and is configured to control the power of the memory storage device 10.

In an exemplary embodiment, the rewritable non-volatile memory module 43 of FIG. 4 may include a flash memory module. In an exemplary embodiment, the memory control circuit unit 42 of FIG. 4 may include a flash memory controller. In an exemplary embodiment, the memory management circuit 51 of FIG. 5 may include a flash memory management circuit.

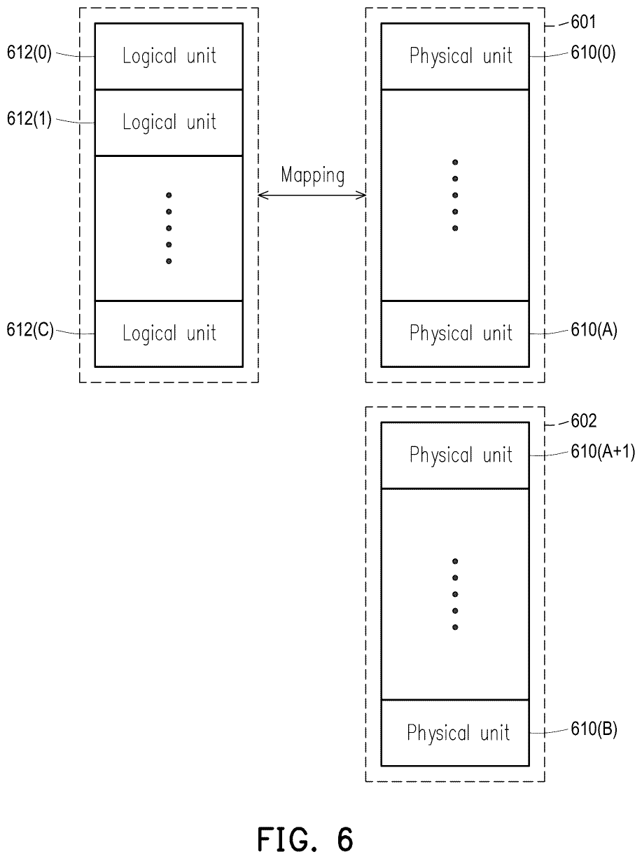

FIG. 6 is a schematic diagram of managing a rewritable non-volatile memory module according to an exemplary embodiment of the disclosure. Please refer to FIG. 6. The memory management circuit 51 may logically group physical units 610(0) to 610(B) in the rewritable non-volatile memory module 43 into a storage area 601 and a spare area 602.

In an exemplary embodiment, a physical unit refers to a physical address or a physical programming unit. In an exemplary embodiment, the physical unit may also be composed of multiple continuous or discontinuous physical addresses. In an exemplary embodiment, the physical unit may also refer to a virtual block (VB). One virtual block may include multiple physical addresses or multiple physical programming units. In an exemplary embodiment, one virtual block may include one or more physical erasing units.

The physical units 610(0) to 610(A) in the storage area 601 are configured to store user data (for example, the user data from the host system 11 of FIG. 1). For example, the physical units 610(0) to 610(A) in the storage area 601 may store valid data and invalid data. The physical units 610(A+1) to 610(B) in the spare area 602 do not store data (for example, valid data). For example, if a certain physical unit does not store valid data, the physical unit may be associated with (or added to) the spare area 602. In addition, the physical units (or the physical units that do not store valid data) in the spare area 602 may be erased. When writing new data, one or more physical units may be extracted from the spare area 602 to store the new data. In an exemplary embodiment, the spare area 602 is also referred to as a free pool.

The memory management circuit 51 may be configured with logical units 612(0) to 612(C) to map the physical units 610(0) to 610(A) in the storage area 601. In an exemplary embodiment, each logical unit corresponds to one logical address. For example, one logical address may include one or more logical block addresses (LBA) or other logical management units. In an exemplary embodiment, one logical unit may also correspond to one logical programming unit or be composed of multiple continuous or discontinuous logical addresses.

It should be noted that one logical unit may be mapped to one or more physical units. If a certain physical unit is currently mapped by a certain logical unit, it means that data currently stored in the physical unit includes valid data. In contrast, if a certain physical unit is not currently mapped by any logical unit, it means that data currently stored in the physical unit is invalid data.

The memory management circuit 51 may record management data (also referred to as logical-to-physical mapping information) describing a mapping relationship between the logical unit and the physical unit in at least one logical-to-physical mapping table. When the host system 11 intends to read data from the memory storage device 10 or write data to the memory storage device 10, the memory management circuit 51 may access the rewritable non-volatile memory module 43 according to information in the logical-to-physical mapping table.

In an exemplary embodiment, the error checking and correcting circuit 54 may include an encoding circuit 541 and a decoding circuit 542. The encoding circuit 541 is configured to encode data. The decoding circuit 542 is configured to decode data. In an exemplary embodiment, the encoding circuit 541 and the decoding circuit 542 may also be combined into a single encoding/decoding circuit.

In an exemplary embodiment, before the memory management circuit 51 writes data to the rewritable non-volatile memory module 43, the data is first encoded to generate corresponding parity data, and the data and the parity data are then stored in the rewritable non-volatile memory module 43, wherein data (also referred to as write data) that the memory management circuit 51 intends to write to the rewritable non-volatile memory module 43 may be, for example, the user data written by the host system 11 or the management data of the memory management circuit 51. When the memory management circuit 51 intends to read a physical unit, the memory management circuit 51 may read the data in the physical unit and the corresponding parity data. The decoding circuit 542 in the error checking and correcting circuit 54 may execute a decoding operation according to the parity data and the data read from the physical unit to detect and correct errors in the data.

In an exemplary embodiment, the error checking and correcting circuit 54 adopts the low-density parity-check codes for encoding and decoding. In the low-density parity-check codes, a check matrix (also referred to as a parity check matrix) is used to define valid codewords. The parity check matrix is denoted as H and the codeword is denoted as CW below. According to Equation (1) below, if the parity check matrix H multiplied by the codeword CW is a zero vector, it means that CW is a valid codeword, wherein the operator×represents matrix multiplication modulo (mod) 2. In other words, a null space of the matrix H contains all the valid codewords. However, the disclosure does not limit the content of the codeword CW. For example, the codeword CW may also include the error correcting code or the error detecting code generated by any algorithm.

$$C W \times {H}^{T} = 0 \qquad ( 1 )$$

The codeword CW may include a message bit and a parity bit, that is, the codeword CW may be expressed as [M P]. The vector M is composed of the message bit. The vector P is composed of the parity bit. The vector M is also referred to as write data (or data to be encoded). The vector P is also referred to as parity data. In a codeword, the parity bit (that is, the parity data) is used to protect the message bit (that is, the write data) and may be regarded as the error correcting code or the error detecting code generated corresponding to the message bit. In addition, protecting the message bit refers, for example, to maintaining the correctness of the message bit. For example, when reading the message bit from the rewritable non-volatile memory module 43, the parity bit corresponding to the message bit may be used to correct possible errors in the message bit.

When decoding the codeword CW, a parity check operation is first executed on the codeword CW. For example, the matrix H is multiplied by the codeword CW to generate a vector (hereinafter denoted as S, as shown in Equation (2) below). Each element in the vector S is also referred to as a syndrome. The vector S is also referred to as syndrome data. If the vector S is a zero vector (that is, every element in the vector S is zero), the codeword CW may be directly output. If the vector S is not a zero vector (that is, at least one element in the vector S is not zero), it means that there is at least one error in the codeword CW and the codeword CW is not a valid codeword. If the codeword CW is not a valid codeword, the error checking and correcting circuit 54 may execute the decoding operation to attempt to correct errors in the codeword CW.

$$C W \times {H}^{T} = S \qquad ( 2 )$$

In an exemplary embodiment, the error checking and correcting circuit 54 executes an iterative decoding operation. One iterative decoding operation is used to decode one piece of data from the rewritable non-volatile memory module 43. The unit of decoding is, for example, one codeword. In an iteration operation, the parity check operation for checking the correctness of the data and the decoding operation for correcting the errors in the data are repeatedly executed until the decoding is successful or the iteration number reaches a termination number. Specifically, if the iteration number reaches the termination number, it means that the decoding fails, and the error checking and correcting circuit 54 stops decoding. The value of the termination number may be designed according to actual requirements, which is not limited by the disclosure. In addition, if it is judged that there is no error in the data via the parity check operation, the error checking and correcting circuit 54 will output the data.

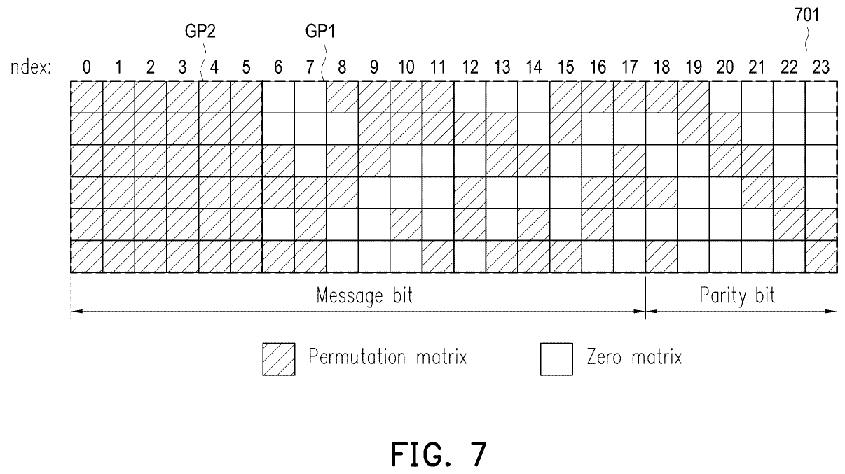

FIG. 7 is a schematic diagram of a codeword according to an exemplary embodiment of the disclosure. Please refer to FIG. 7. Assuming that the data read from the rewritable non-volatile memory module 43 includes a codeword 701 (also referred to as a first codeword), in the parity check operation, according to Equation (2), the parity check matrix H may be multiplied by the codeword 701 to obtain the vector S. If the vector S is a zero vector, it means there is no error bit in the codeword 701, and the error checking and correcting circuit 54 may directly output the codeword 701. In contrast, if the vector S is not a zero vector, it means that the codeword 701 has at least one error bit, and the error checking and correcting circuit 54 executes the decoding operation for correcting the error bit in the codeword on the codeword 701.

In an exemplary embodiment, the codeword 701 is composed of multiple matrices, and the matrices may respectively, for example, be a permutation matrix and a zero matrix. The codeword 701 may be expressed as 24 columns, as shown in FIG. 7, and each column has a unique index. The 1st column in the codeword 701 corresponds to index 0, the 2nd column in the codeword 701 corresponds to index 1, and so on. In an exemplary embodiment, the 1st column to the 18th column in the codeword 701 are composed of message bits, and the 19th column to the 24th column in the codeword 701 are composed of parity bits.

In an exemplary embodiment, each column in the codeword 701 has a different decoding ability. For example, the 1st column to the 6th column in the codeword 701 are respectively composed of a permutation matrix. In an exemplary embodiment, each permutation matrix may be, for example, a check node. Specifically, the 1st column to the 6th column in the codeword 701 respectively have 6 check nodes. Similarly, the 7th column to the 19th column in the codeword 701 respectively have 3 check nodes. The 20th column to the 24th column in the codeword 701 respectively have 2 check nodes. The more check nodes a column in the codeword 701 has, the higher the decoding ability. In other words, the decoding abilities of the 1st column to the 6th column in the codeword 701 are the highest, the decoding abilities of the 7th column to the 19th column are the second highest, and the decoding abilities of the 20th column to the 24th column are the lowest.

In an exemplary embodiment, when decoding the codeword 701, the error checking and correcting circuit 54 executes the iterative decoding operation. The memory management circuit 51 (error checking and correcting circuit 54) may execute the decoding operation according to the codeword 701. Specifically, one iteration operation is, for example, the memory management circuit 51 (error checking and correcting circuit 54) completing one parity check operation (and decoding operation) for the complete codeword 701. For example, the memory management circuit 51 may sequentially calculate from the 1st column in the codeword 701 to the 24th column in the codeword 701 to judge whether there is any error in the codeword 701, and output the codeword 701 in response to no error or attempt to correct the error in the codeword 701 in response to an error, thereby completing one iteration operation.

Generally speaking, each iteration operation of the iterative decoding operation is executed according to all the columns in the codeword 701. However, the decoding ability of each column in the codeword 701 is different, and the number of times the decoding operation needs to be executed is also different. The error bits in the data may be successfully corrected during the decoding operation, so that the errors approach convergence. For example, the 1st column to the 6th column in the codeword 701 have the highest decoding abilities (that is, the decoding abilities of bits included in the 1st column to the 6th column are the highest), and the convergence speeds of the 1st column to the 6th column in the codeword 701 are the fastest. For example, the 20th column to the 24th column in the codeword 701 have the lowest decoding abilities (that is, the decoding abilities of bits included in the 20th column to the 24th column are the lowest), and the convergence speeds of the 20th column to the 24th column in the codeword 701 are the slowest. For example, the bits included in the 1st column to the 6th column of the codeword 701 may be converged within a predetermined number of iteration operations, that is, the error bits in the 1st column to the 6th column of the codeword 701 may be corrected within the predetermined number of iteration operations. In other words, the error bits in the 7th column to the 24th column of the codeword 701 may need to undergo a greater number (greater than the predetermined number) of iteration operations before being corrected.

According to the above, the conventional iterative decoding operation (that is, the manner of executing each decoding operation according to all the columns in the codeword 701) may execute unnecessary calculations on the converged bits in the subsequent iteration operations. Therefore, the disclosure provides a dynamic decoding method, which may execute the corresponding decoding operation for the current iteration number, and may improve the decoding speed while maintaining the error correction ability.

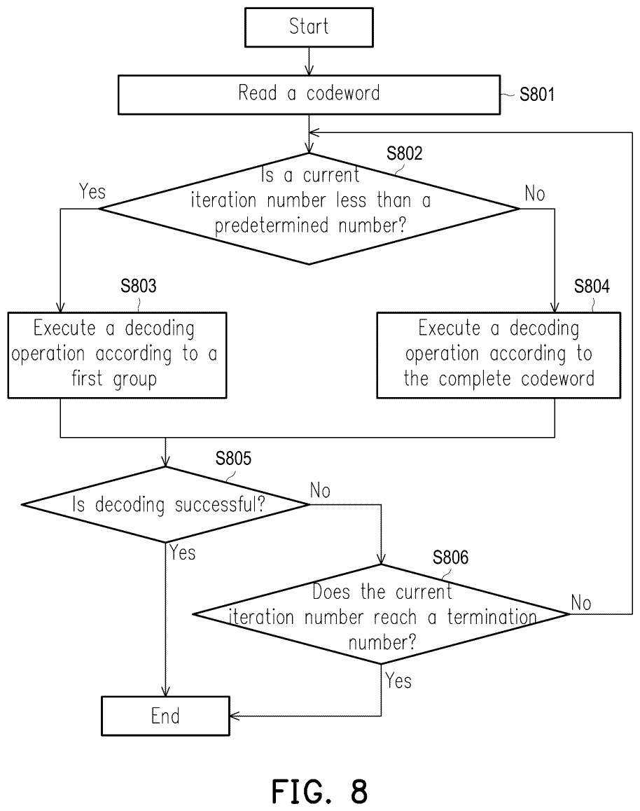

FIG. 8 is a flowchart of a dynamic decoding method according to an exemplary embodiment of the disclosure. Please refer to FIG. 8. In step S801, the memory management circuit 51 may read the codeword 701 from the physical unit of the rewritable non-volatile memory module 43. In an exemplary embodiment, the memory management circuit 51 may group the codeword 701 into a first group GP1 and a second group GP2. Specifically, the memory management circuit 51 may group the codeword 701 into the first group GP1 and the second group GP2 based on the decoding ability, wherein the decoding ability of the first group GP1 is lower than the decoding ability of the second group GP2. For example, the memory management circuit 51 may group the codeword 701 based on the number of check nodes included in each column of the codeword 701. For example, the memory management circuit 51 may group the codeword 701 according to a predetermined number (for example, 4). If the number of check nodes included in a column in the codeword 701 is less than 4, the column may be grouped into the first group GP1. In contrast, if the number of check nodes included in a column in the codeword 701 is not less than 4, the column may be grouped into the second group GP2. In other words, the memory management circuit 51 may group the 7th column to the 24th column in the codeword 701 into the first group GP1, and group the 1st column to the 6th column in the codeword 701 into the second group GP2. The value of the predetermined number may be designed according to actual requirements, which is not limited by the disclosure.

In another embodiment, the memory management circuit 51 may also, for example, group the columns with the same number of check nodes in the codeword 701 into the same group. For example, the memory management circuit 51 may respectively group the 1st column to the 6th column, the 7th column to the 19th column, and the 20th column to the 24th column of the codeword 701 into a group. In another embodiment, the memory management circuit 51 may also, for example, perform grouping in advance when executing an encoding operation according to the write data (or the data to be encoded) to distinguish between a group with weaker decoding ability and another group with stronger decoding ability, and store the two groups in the physical unit of the rewritable non-volatile memory module 43. Thereafter, when the memory management circuit 51 intends to read the physical unit, the memory management circuit 51 may first read the group with weaker decoding ability to execute the decoding operation.

In step S802, the memory management circuit 51 may judge whether the current iteration number is less than a predetermined number. In an exemplary embodiment, the memory management circuit 51 may judge whether the current iteration number is less than a predetermined number (for example, 3 times) to determine whether to execute the decoding operation according to the complete codeword 701 or to execute the decoding operation according to a partial codeword (for example, the first group GP1).

If the current iteration number (for example, the 1st time) is less than the predetermined number, the process proceeds to step S803, which is the 1st iteration operation in the iterative decoding operation at this time. In contrast, if the current iteration number is not less than the predetermined number, the process proceeds to step S804. The value of the predetermined number may be designed according to actual requirements, which is not limited by the disclosure.

In step S803, the memory management circuit 51 (error checking and correcting circuit 54) may execute the decoding operation according to the first group GP1. In an exemplary embodiment, the memory management circuit 51 (error checking and correcting circuit 54) may first execute the decoding operation on the 1st column of the first group GP1 (that is, the 7th column of the codeword 701), and then check whether the syndrome data of the complete codeword 701 is equal to zero.

If the syndrome data is equal to zero, it means that there is no error in the codeword 701, and the memory management circuit 51 (error checking and correcting circuit 54) may directly output the codeword 701.

In contrast, if the syndrome data is not equal to zero, it means that there is an error in the codeword 701. The memory management circuit 51 (error checking and correcting circuit 54) may execute the decoding operation on other columns of the first group GP1 (that is, the 8th column to the 24th column of the codeword 701) to attempt to correct the error in the first group GP1, so that the error in the first group GP1 approaches convergence.

It should be noted that since the decoding ability of the first group GP1 is lower, the first group GP1 may need to be decoded multiple times before convergence. Therefore, the memory management circuit 51 (error checking and correcting circuit 54) may execute the decoding operation only according to the first group GP1 within the predetermined number of iteration operations, and the second group GP2 with higher decoding ability and faster convergence may be decoded in subsequent iteration operations. In this way, the decoding speed may be effectively improved.

On the other hand, in step S804, the memory management circuit 51 (error checking and correcting circuit 54) may execute the decoding operation according to the complete codeword 701. In an exemplary embodiment, the memory management circuit 51 (error checking and correcting circuit 54) may first execute the decoding operation on the 1st column in the codeword 701, and then check whether the syndrome data of the complete codeword 701 is equal to zero.

If the syndrome data is equal to zero, it means that there is no error in the codeword 701, and the memory management circuit 51 (error checking and correcting circuit 54) may directly output the codeword 701.

In contrast, if the syndrome data is not equal to zero, it means that there is an error in the codeword 701. The memory management circuit 51 (error checking and correcting circuit 54) may execute the decoding operation on other columns of the codeword 701 (that is, the 2nd column to the 24th column of the codeword 701) to attempt to correct the error in the codeword 701, so that the error in the codeword 701 approaches convergence, wherein if all the errors in the codeword 701 are corrected, the memory management circuit 51 (error checking and correcting circuit 54) may output the codeword 701.

Thereafter, after completing step S803 or step S804, the process proceeds to step S805. In step S805, the memory management circuit 51 (error checking and correcting circuit 54) may judge whether the decoding is successful. Specifically, the memory management circuit 51 (error checking and correcting circuit 54) may judge whether the decoding is successful according to whether the codeword 701 has been output. If the memory management circuit 51 (error checking and correcting circuit 54) has output the codeword 701, it means that the decoding is successful, and the dynamic decoding method of FIG. 8 may end.

In contrast, if the memory management circuit 51 (error checking and correcting circuit 54) has not output the codeword 701, it means that the decoding is not successful, and the process proceeds to step S806.

In step S806, the memory management circuit 51 (error checking and correcting circuit 54) may judge whether the current iteration number reaches the termination number.

If the current iteration number does not reach the termination number, the process return to step S802.

In contrast, if the current iteration number reaches the termination number, it means that the decoding fails, and the dynamic decoding method of FIG. 8 ends. In an exemplary embodiment, the memory management circuit 51 (error checking and correcting circuit 54) may continue to perform further decoding operations (for example, a soft bit decoding operation, a redundant array of independent disks (RAID) decoding operation, etc.) after the dynamic decoding method of FIG. 8 ends.

According to the above, in the dynamic decoding method of FIG. 8, in response to the current iteration number being less than the predetermined number, the decoding operation may be executed only on the first group GP1 with low decoding ability in the codeword 701, and in response to the current iteration number being not less than the predetermined number, the decoding operation may be executed on the complete codeword 701 (that is, the first group GP1 and the second group GP2), so as to reduce the number of times of decoding of the second group GP2 with high decoding ability, thereby preventing executing unnecessary calculations on the converged bits, which may improve the decoding speed while maintaining the error correction ability.

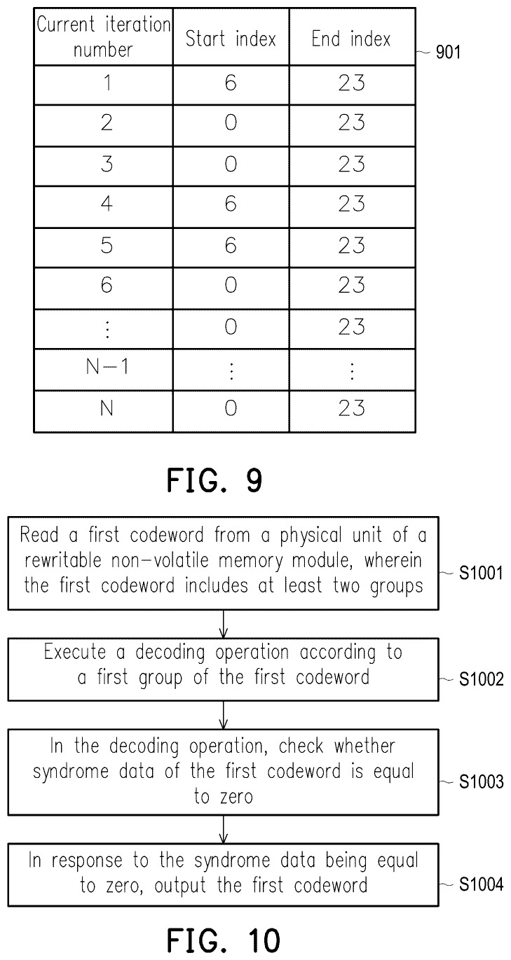

FIG. 9 is a schematic diagram of a lookup table according to an exemplary embodiment of the disclosure. Please refer to FIG. 9. A lookup table 901 records a start index and an end index corresponding to the current iteration number. In an exemplary embodiment, the memory management circuit 51 may group the codeword 701 into the first group GP1 and the second group GP2. Specifically, the memory management circuit 51 may group the codeword 701 into the first group GP1 with low decoding ability and the second group GP2 with high decoding ability. The implementation details of grouping the codeword 701 into the first group GP1 and the second group GP2 have been clearly described in the foregoing exemplary embodiment and will not be repeated here. It should be noted that the codeword 701 may be grouped into at least two groups. The number of groups may be designed according to actual requirements, which is not limited by the disclosure.

Thereafter, the memory management circuit 51 may establish the lookup table 901 based on the first group GP1 and the second group GP2. As shown in FIG. 9, the lookup table 901 includes but is not limited to the current iteration number, the start index, and the end index. The start index is an index corresponding to a start column of a decoding operation, and the end index is an index corresponding to an end column of a decoding operation. N is the termination number of the iterative decoding operation. The value of the termination number (that is, N) may be designed according to actual requirements, which is not limited by the disclosure.

In an exemplary embodiment, in response to the current iteration number being less than a predetermined number (for example, 6 times), the memory management circuit 51 may selectively not execute the decoding operation according to the complete codeword 701. As shown in FIG. 9, if the current iteration number is 1, the current iteration number is 4, and the current iteration number is 5, the start index and the end index are respectively 6 and 23, and if the current iteration number is 2 and the current iteration number is 3, the start index and the end index are respectively 0 and 23. In other words, the 1st iteration operation, the 4th iteration operation, and the 5th iteration operation are the decoding operations executed according to the 7th column to the 24th column of the codeword 701 (that is, the first group GP1), and the 2nd iteration operation and the 3rd iteration operation are the decoding operations executed according to the 1st column to the 24th column of the codeword 701 (that is, the complete codeword 701). In contrast, in response to the current iteration number being not less than the predetermined number (that is, 6 times), the memory management circuit 5 may execute the decoding operation according to the complete codeword 701. In other words, if the current iteration number is one of 6 to N, the start index and the end index are respectively 0 and 23, that is, the 6th iteration operation to the Nth iteration operation are the decoding operations executed according to the complete codeword 701.

In an exemplary embodiment, after the memory management circuit 51 reads the codeword 701 from the rewritable non-volatile memory module 43, as shown in FIG. 9, the memory management circuit 51 (error checking and correcting circuit 54) may perform a 1st iteration operation. As shown in FIG. 9, the memory management circuit 51 (error checking and correcting circuit 54) may execute the decoding operation according to the first group GP1. Specifically, the memory management circuit 51 (error checking and correcting circuit 54) may first execute the decoding operation on the 1st column of the first group GP1, and then check whether the syndrome data of the codeword 701 is equal to zero. If the syndrome data is equal to zero, it means that there is no error in the codeword 701, and the memory management circuit 51 (error checking and correcting circuit 54) may directly output the codeword 701.

On the other hand, if the syndrome data is not equal to zero, it means that there is an error in the codeword 701. The memory management circuit 51 (error checking and correcting circuit 54) may execute the decoding operation on other columns of the first group GP1, so that the errors in the first group GP1 gradually converge to improve the decoding success rate. Thereafter, the memory management circuit 51 (error checking and correcting circuit 54) may continue to execute a 2nd iteration operation. As shown in FIG. 9, the memory management circuit 51 (error checking and correcting circuit 54) may execute the decoding operation according to the complete codeword 701. The implementation details of executing the decoding operation according to the complete codeword 701 have been clearly described in the foregoing exemplary embodiment and will not be repeated here.

In other words, after completing the decoding operation (that is, the 1st iteration operation) executed according to the first group GP1, in response to the syndrome data of the codeword 701 being not equal to zero (that is, the decoding is not successful), the memory management circuit 51 (error checking and correcting circuit 54) may execute the decoding operation (that is, the 2nd iteration operation) executed according to the complete codeword 701. It should be noted that in the 1st iteration operation, the memory management circuit 51 (error checking and correcting circuit 54) executes the decoding operation on the first group GP1, so that the errors in the first group GP1 approach convergence, thereby improving the decoding success rate. Therefore, in the 2nd iteration operation, the memory management circuit 51 (error checking and correcting circuit 54) may execute the decoding operation according to the complete codeword 701 instead. Since the errors in the first group GP1 are relatively converged, there is a chance of the decoding being successful.

According to the above, the memory management circuit 51 may establish the lookup table 901 according to the decoding abilities and the actual requirements of all the columns of the codeword 701, and may selectively reduce the decoding operations executed according to the complete codeword 701 in response to the current iteration number being less than the predetermined number, thereby improving the decoding speed while maintaining the error correction ability.

FIG. 10 is a flowchart of a dynamic decoding method according to an exemplary embodiment of the disclosure. Please refer to FIG. 10. In step S1001, a first codeword is read from a physical unit of a rewritable non-volatile memory module, wherein the first codeword includes at least two groups. In step S1002, a decoding operation is executed according to a first group of the first codeword. In step S1003, in the decoding operation, whether syndrome data of the first codeword is equal to zero is checked. In step S1004, in response to the syndrome data being equal to zero, the first codeword is output.

However, each step in FIG. 10 has been described in detail above and will not be repeated here. It should be noted that each step in FIG. 10 may be implemented as multiple program codes or circuits, which is not limited by the disclosure. In addition, the method of FIG. 10 may be used in conjunction with the foregoing exemplary embodiments or may be used alone, which is not limited by the disclosure.

In summary, in the dynamic decoding method, the memory storage device, and the memory control circuit unit provided by the exemplary embodiments of the disclosure, in response to the current iteration number being less than the predetermined number, the decoding operation may be selectively executed only on the first group with low decoding ability in the codeword, and in response to the current iteration number being not less than the predetermined number, the decoding operation may be executed on the complete codeword, which may prevent executing unnecessary calculations on the converged bits, thereby improving the decoding speed while maintaining the error correction ability.

What is claimed is:

1. A dynamic decoding method for a rewritable non-volatile memory module, the dynamic decoding method comprising:
reading a first codeword from a physical unit of the rewritable non-volatile memory module, wherein the first codeword comprises at least two groups;
executing a decoding operation according to a first group of the first codeword;
checking whether syndrome data of the first codeword is equal to zero in the decoding operation; and
outputting the first codeword in response to the syndrome data being equal to zero.

2. The dynamic decoding method according to claim 1, further comprising:
executing the decoding operation according to the complete first codeword after completing the decoding operation executed according to the first group in response to the syndrome data being not equal to zero.

3. The dynamic decoding method according to claim 1, further comprising:
judging whether a current iteration number of the decoding operation is less than a predetermined number; and
executing the decoding operation according to the first group in response to the current iteration number being less than the predetermined number.

4. The dynamic decoding method according to claim 3, further comprising:
executing the decoding operation according to the complete first codeword in response to the current iteration number being not less than the predetermined number.

5. The dynamic decoding method according to claim 1, wherein decoding abilities of the at least two groups are different, and the decoding ability of the first group is lower than the decoding ability of a second group of the first codeword.

6. The dynamic decoding method according to claim 1, further comprising:
establishing a lookup table based on the at least two groups; and
querying the lookup table according to a current iteration number of the decoding operation to judge whether to execute the decoding operation according to one of the at least two groups or the complete first codeword.

7. A memory storage device, comprising:
a connection interface unit, configured to couple to a host system;
a rewritable non-volatile memory module; and
a memory control circuit unit, coupled to the connection interface unit and the rewritable non-volatile memory module,
wherein the memory control circuit unit is configured to:
issue a read command sequence to the rewritable non-volatile memory module, wherein the read command sequence is configured to instruct to read a first codeword from a physical unit of the rewritable non-volatile memory module, wherein the first codeword comprises at least two groups;
execute a decoding operation according to a first group of the first codeword;
check whether syndrome data of the first codeword is equal to zero in the decoding operation; and
output the first codeword in response to the syndrome data being equal to zero.

8. The memory storage device according to claim 7, wherein the memory control circuit unit is further configured to:
execute the decoding operation according to the complete first codeword after completing the decoding operation executed according to the first group in response to the syndrome data being not equal to zero.

9. The memory storage device according to claim 7, wherein the memory control circuit unit is further configured to:
judge whether a current iteration number of the decoding operation is less than a predetermined number; and
execute the decoding operation according to the first group in response to the current iteration number being less than the predetermined number.

10. The memory storage device according to claim 9, wherein the memory control circuit unit is further configured to:
execute the decoding operation according to the complete first codeword in response to the current iteration number being not less than the predetermined number.

11. The memory storage device according to claim 7, wherein decoding abilities of the at least two groups are different, and the decoding ability of the first group is lower than the decoding ability of a second group of the first codeword.

12. The memory storage device according to claim 7, wherein the memory control circuit unit is further configured to:
establish a lookup table based on the at least two groups; and
query the lookup table according to a current iteration number of the decoding operation to judge whether to execute the decoding operation according to one of the at least two groups or the complete first codeword.

13. A memory control circuit unit, disposed in a memory storage device, the memory control circuit unit comprising:
a host interface, configured to couple to a connection interface unit;
a memory interface, configured to couple to a rewritable non-volatile memory module; and
a memory management circuit, coupled to the host interface and the memory interface,
wherein the memory management circuit is configured to:
issue a read command sequence to the rewritable non-volatile memory module, wherein the read command sequence is configured to instruct to read a first codeword from a physical unit of the rewritable non-volatile memory module, wherein the first codeword comprises at least two groups;
execute a decoding operation according to a first group of the first codeword;
check whether syndrome data of the first codeword is equal to zero in the decoding operation; and
output the first codeword in response to the syndrome data being equal to zero.

14. The memory control circuit unit according to claim 13, wherein the memory management circuit is further configured to:
execute the decoding operation according to the complete first codeword after completing the decoding operation executed according to the first group in response to the syndrome data being not equal to zero.

15. The memory control circuit unit according to claim 13, wherein the memory management circuit is further configured to:
judge whether a current iteration number of the decoding operation is less than a predetermined number; and
execute the decoding operation according to the first group in response to the current iteration number being less than the predetermined number.

16. The memory control circuit unit according to claim 15, wherein the memory management circuit is further configured to:
execute the decoding operation according to the complete first codeword in response to the current iteration number being not less than the predetermined number.

17. The memory control circuit unit according to claim 13, wherein decoding abilities of the at least two groups are different, and the decoding ability of the first group is lower than the decoding ability of a second group of the first codeword.

18. The memory control circuit unit according to claim 13, wherein the memory management circuit is further configured to:
establish a lookup table based on the at least two groups; and
query the lookup table according to a current iteration number of the decoding operation to judge whether to execute the decoding operation according to one of the at least two groups or the complete first codeword.
